(19) United States
(12) Patent Application Publication
(10) Pub. No.: US 2007/0063669 A1
(43) Pub. Date: Mar. 22, 2007

(54) Portable battery charger

(76) Inventor: Michael J. Keating, Hardwick, NJ (US)

Correspondence Address: Ward & Olivo, Suite 400, 382 Springfield Avenue, Summit, NJ, 07901, US

(21) Appl. No.: 11/232,448

(22) Filed: Sep. 21, 2005

(51) Int. Cl. H02J 7/00

(52) U.S. Cl. 320/107

(57) ABSTRACT

Disclosed is a portable charger adapted for use with wireless devices. Integrated circuitry controls the amount of current charge delivered to the primary power source of a wireless device through an adaptor. The current charge is delivered by a power source located within an attractive housing. A light emitting diode coupled to the integrated circuit indicates whether the wireless device is actively being charged.

### FIELD OF THE INVENTION

The invention relates generally to the field of battery chargers. More specifically, the current invention is directed to portable battery chargers for portable media devices.

### BACKGROUND OF THE INVENTION

Today's fast-paced, global marketplace requires constant communication between parties. Indeed, the ability to communicate with potential clients, vendors, or manufacturers is vital to an entity's success. As a result, entities and individuals require wireless communication devices capable of being utilized at any geographical location at any time. While many such devices are known, the most common of these is the portable telephone, also known as a cellular telephone.

All cellular telephones and portable personal entertainment units (i.e., MP3 players) are electronic devices. As such, they require a power source. For example, most cellular telephones utilize a battery. During operation, the battery provides electrical energy to both a transmitter and a receiver of the cellular telephone. As the cellular telephone is utilized, the energy stored in the battery energy is consumed. Over time, this will drain the battery of all of its electrical energy. As a result, the power source of the cellular telephone must be replaced or replenished.

Replacing batteries is often cost-prohibitive due to the expense associated with wireless device batteries. A cheaper alternative utilizes a rechargeable battery scheme which allows a user to more frequently utilize the cellular telephone. However, conventional rechargeable batteries require bulky chargers which require conventional power sources such as an electrical outlet to recharge the battery. Therefore, a user must remain in close proximity to a conventional power source which hampers the portability of wireless devices utilizing such batteries.

In addition, the battery charger is usually only adapted for use with a single type of battery because the input jack of each rechargeable battery is different. As a result, a user of multiple communication devices must carry several of these bulky, inconvenient chargers.

To overcome some of the problems associated with conventional battery chargers alternatives have been developed. For instance, there are portable chargers that utilize a secondary battery source (e.g., a single or multitude of “AA” battery(s)) to charge the primary cellular telephone battery. These chargers often come with adapters which allow a user to utilize the charger with a plurality of mobile devices. In operation, some of these chargers utilize a circuit to boost their electrical output to match the requirements of the primary cellular telephone battery.

Importantly, however, a number of these chargers do not have a means to regulate the amount of energy delivered nor do they limit the maximum rate at which energy is supplied to the primary cellular telephone battery. Instead with a number of prior art/existing systems, a user must manually disconnect the charging device to regulate the amount of energy distributed to the battery. If a user forgets to disconnect the portable charger, it will continue to supply a charge to the primary battery. If the primary battery receives an excessive amount of energy it may overload and become damaged. If the primary battery becomes damaged, its usable capacity typically becomes degraded and a user must purchase a costly replacement battery in order to maintain maximum usage time.

In light of the foregoing, there exists a clear need in the art for an adaptable, portable wireless device charger which is capable of regulating the amount of energy distributed to the primary battery of a portable wireless device.

### SUMMARY OF THE INVENTION

The present invention discloses a portable charger adapted for use with wireless devices. Importantly, the portable charger does not require an AC connection. At least one integrated circuit located within the housing of the battery charger controls the amount of current charge delivered to the primary power source of a wireless device and the maximum rate at which it is delivered. The current charge is delivered by a power source located within the housing of the battery charger and is electrically coupled to the integrated circuit. A means for attaching the battery charger to a wireless device is electrically coupled to the integrated circuit. Advantageously, the attachment means is one of a plurality of adaptors. This allows a user of the device to charge the battery of a plurality of wireless devices with a single battery charger. A light emitting diode coupled to the integrated circuit indicates whether the wireless device is actively being charged.

The integrated circuitry (which may be implemented with a single custom ASIC or a plurality of “off the shelf” IC's) comprises a novel combination of well known components including a differential op amp, a boost converter, and a comparator.

While battery chargers for portable devices are well known, the present invention is an improvement over the prior art in that it utilizes a sensor located within the integrated circuit topology that monitors current flow into the wireless device. This prevents the battery charger from high rate overcharging the primary battery of the device and preserves the life of the primary battery. This also protects the charger's circuitry against accidental short circuit connection.

Also disclosed is a method of charging the primary power source of a wireless device or other primary battery powered consumer product. The method comprises the steps of providing a battery charger in accordance with the present invention, attaching the battery charger to a wireless device, and charging the power source of a wireless device. The present invention advantageously utilizes an interchangeable interconnect system in the form of a plurality of adaptors. These adaptors directly attach to the battery charger and the wireless device. As a result, the battery charger of the present invention can be used to recharge the power supply of a variety of different wireless devices or primary battery powered portable consumer products, eliminating confusing conventional chargers.

In addition, the current invention is portable and does not require a conventional power source requiring an AC connection. Instead, it utilizes secondary batteries which are disposed in its housing. This eliminates the need for a user to remain in close proximity to a static power source (such as an AC line connection), which provides greater flexibility in using the wireless device.

In accordance with the foregoing, it is an object of the invention to create a portable wireless device charger.

Still another object of the current invention is to provide a portable cellular telephone charger.

Further, it is an object of the present invention to provide a portable wireless device charger which will not damage the primary rechargeable battery and will inherently protect itself against damage from short circuit connection.

Yet another object of the present invention is to utilize a method of charging a rechargeable battery without damaging the rechargeable battery.

Still another object of the present invention is to provide a portable, wireless device charger which can be used with a plurality of communications devices.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention. Reference is now made of the drawings in which:

FIG. 1 is a diagram of a portable charging system in accordance with the present invention

FIG. 2 is a diagram of the constituent parts of a disassembled portable charger in accordance with the present invention

FIG. 3 is a sectional view of a battery charger in accordance with the present invention

FIG. 4 depicts various adaptors which can be used in conjunction with the portable charger in accordance with the present invention

FIG. 5 is a circuit diagram of an over-current protected and regulated DC-DC converter and charge delivery sense circuitry in accordance with the present invention

FIG. 6 is a flow diagram of a method of utilizing a portable charger in accordance with the present invention

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein that define the scope of the present invention.

Initially, the use of the terms “cellular telephone,” “cell phone,” “wireless device,” “media device,” and the like are not meant to limit the scope of the present invention. Rather, the terms are used interchangeably and are meant to be merely illustrative in nature of certain aspects of the present invention.

In addition, the terms “charger,” “portable charger,” “device charger,” and the like are not meant to limit the scope of the present invention. These terms are also used interchangeably and are meant to be merely illustrative in nature of certain aspects of the present invention.

Moreover, well known methods, procedures, and substances for both carrying out the objectives of the present invention and illustrating the preferred embodiment are incorporated herein but have not been described in detail as not to unnecessarily obscure aspects of the present invention.

Finally, while the foregoing description describes the preferred embodiment only in relation to a cellular telephone, it will be appreciated by those of skill in the art that the invention described herein can be used with other portable media devices. Non-limiting examples include: MP3 players, Blackberry® devices manufactured by Research In Motion, Inc., iPod® music players, and the like. The following presents a detailed description of a preferred embodiment of the present invention.

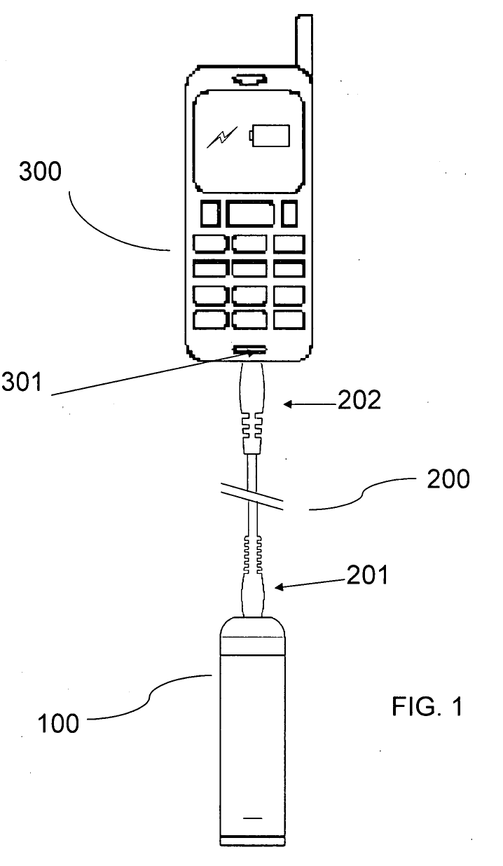

Referring now to FIG. 1, disclosed is the general system of the present invention. Battery charger 100 and wireless device 300 are electrically coupled to each other by attachment means 200. Wireless device is any well known wireless device that utilizes a rechargeable power source. Examples include a cellular telephone, a portable digital assistant, a digital media storage device, a digital media playback device, a digital media transmitting device, a digital media receiving device, an iPod®, and a blackberry®. Of course, any wireless device can be used in accordance with the preferred embodiment without departing from the spirit of the invention.

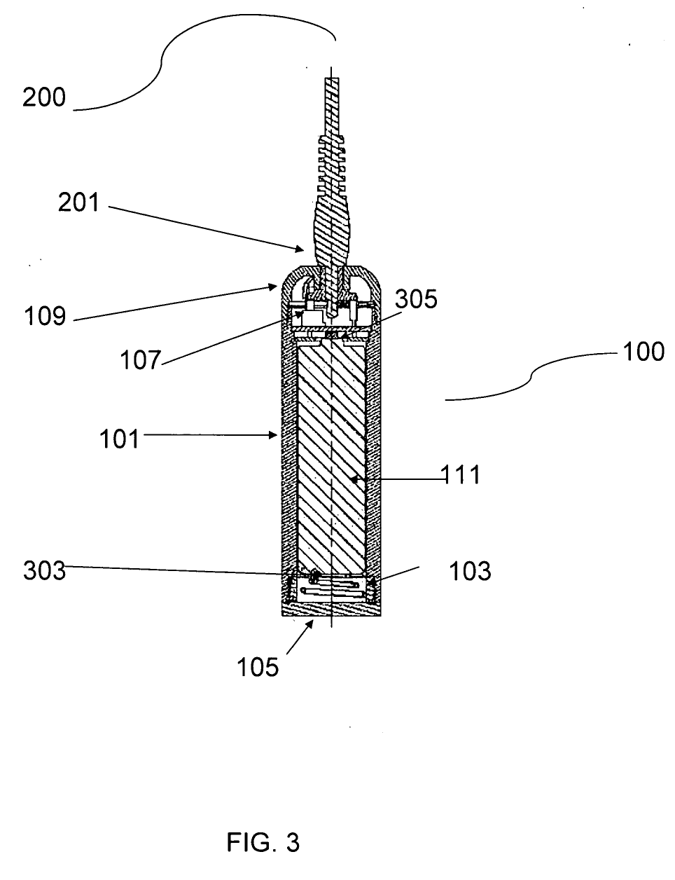

Wireless device 300 is powered by rechargeable primary battery source with an input 301. Attachment means 200 has a terminus 202 that attaches to wireless device 300 at input 301. Attachment means 200 also has a second terminus 201 which is electrically coupled to battery charger 100 on integrated circuit 107 as depicted in FIG. 3.

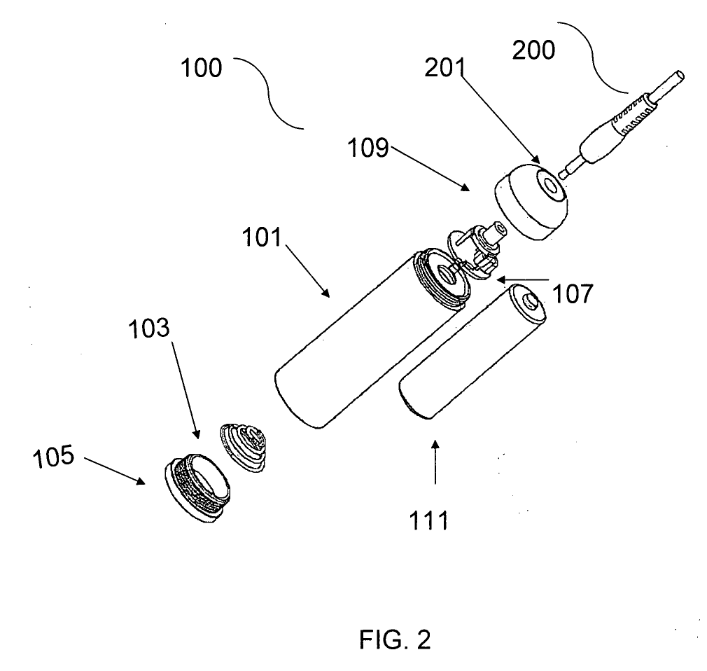

Turning now to FIGS. 2-3, shown are the components of battery charger 100. Battery charger 100 is comprised of hollow housing 101 with base 105 and top 109. Base 105 and top 109 are attached to housing 101 by any conventional well known means. For example, base 105 and top 109 can be permanently attached to housing 101 via adhesive, via a snap-on means, or via a clip-on means. In a preferred embodiment, base 105, top 109, and housing 101 are all threaded so that the components are removably attached.

In a preferred embodiment, housing 101 and base 105 is comprised of a lightweight, inexpensive metal. Of course, any material can be used without departing from the spirit of the present invention. Preferably top 109 is made of a clear plastic material so a user can see a light emitting diode (not shown) disposed within the housing. However, top 109 can be made of any material.

While housing 101 can be any shape, preferably the shape is cylindrical to accommodate power source 111. Power source 111 can be any well known electrical power source, however, it is preferred that power source 111 is a battery. Power source 111 can be a disposable, alkaline or lithium primary battery or a rechargeable secondary battery such as a nickel/cadmium battery. Preferably, the battery is a standard “AA” sized alkaline battery. Of course, any other well known size or type of battery can be used without departing from the spirit of the invention.

Spring 103 is oriented in housing 101 such that it remains in contact with a terminus of power source 111. Preferably, spring 103 is located within base 105 and is comprised of metal. Of course, spring 103 can be oriented at the other terminus of power source 111. Integrated circuit 107 (discussed in detail below) is disposed within housing 101 such that it is in contact with power source 111. In a preferred embodiment, integrated circuit 107 and spring 103 contact power source at opposing ends of power source 111.

FIG. 3 is a sectional view of the assembled components of battery charger 100. As depicted, power source 111 is in contact with spring 103 and integrated circuit 107. A charge current is derived from between points 303 and 305 and travels through integrated circuit 107. The charge energy/power passes through terminus 201 of attachment means 200 because terminus 201 is in electrical contact with integrated circuit 107.

Attachment means 200 is any well known means of connecting two power sources. For example, attachment means 200 can be an electrically conductive wire. Of course, any other well known attachment means can be used without departing from the spirit of the present invention.

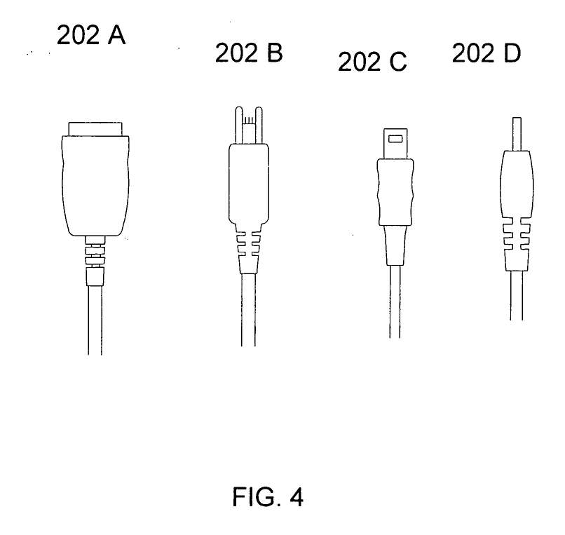

Attachment means 200 further comprises second terminus 202. Advantageously, second terminus 202 can have several different configurations, examples of which are depicted in FIG. 4. For example, second terminus 202A is designed to attach to an input of a primary power source of a Samsung® cellular telephone. Similarly, second terminus 202B is designed to attach to an input of a primary power source for a Nextel® cellular telephone, second terminus 202C is designed to attach to an input for a primary power source of a Motorola® cellular telephone, and second terminus 202D is designed to attach to an input for a primary power source of a Nokia® cellular telephone. By providing a plurality of varying attachment means, a user can utilize the battery charger of the present invention with a plurality of wireless devices. Of course, any other type of terminus is can be used without departing from the spirit of the present invention.

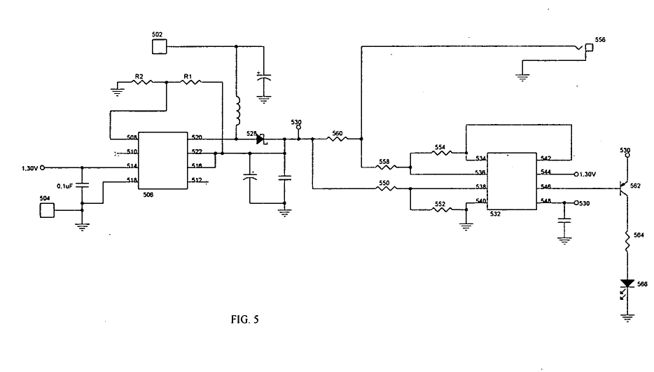

Referring now to FIG. 5, depicted is a schematic of integrated circuit 107 according to the preferred embodiment of battery charger 100. The schematic depicts connection 502 to the positive terminal of power supply 111 and second connection 504 to the negative terminal of power supply 111. Integrated circuit 107 then employs MAX1675 High-Efficiency, Low-Supply-Current, Compact, Step-Up DC-DC Converter 506 to step the 1.5 volt power supplied by the power supply.

DC-DC Converter 506 has eight connections 508, 510, 512, 514, 516, 518, 520, and 522. Low-Battery Comparator Input 510 and Low-Battery Comparator Output 512 are not electrically connected to any other component. Ground 518 is tied to second connection 504 at the negative terminus of power supply 111, while reference voltage 514 is electrically connected to 1.3 volts. Shutdown Input 516 is connected to power output 522. This connection facilitates normal operation of DC-DC converter 506 without employing its shutdown capabilities. N-Channel and P-Channel Power MOSFET Drain 520 is connected through zener diode 528 to power output 522.

Dual-Mode™ Feedback Input 508 is connected to a resistor network to set the output voltage. Using such a resistor network allows the voltage to be set to preferably between 2.0 volts and 5.5 volts. However, it is contemplated that other resistor networks can be implemented that utilize different voltage ranges. For instance, other well known resistor values can be connected in parallel or in series as is well known in the art to increase or decrease the voltage range. Resistor 524 which ties Dual-Mode™ Feedback Input 508 to ground 518 is preferably 200 kΩ. Resistor 526, which connects Dual-Mode™ Feedback Input 508 to power output 522, is preferably 422 kΩ. Of course, other values can be used without departing from the spirit of the invention. The preferred embodiment produces an output voltage at power output 522 based on resistors 524 and 526 in the resistor network and reference voltage 514 per the following formula:

$${V}_{522} = {V}_{514} [ \frac{{R}_{526}}{{R}_{524}} + 1 ]$$

The voltage at output 530 of DC-DC converter 506 is preferably 4.1 volts. However, the voltage output can be raised or lowered to accommodate other charge current requirements.

The Charge current that is delivered to 556 is “sensed” by TLV27021DGK Operational Amplifier and Push-Pull Comparator 532 by the voltage difference across resistor 560. Comparator/amplifier 532 has connections 534, 536, 538, 540, 542, 544, 546, and 548 and is configured as both a differential operational amplifier and a comparator. Preferably, supply voltage 548 is connected to power output 530 of comparator/amplifier 532 and fixed at 4.1 volts.

The differential operational amplifier has inputs 536 and 538 on comparator/amplifier 532. The positive input 538 of comparator/amplifier 532 is connected to power output 530 of DC-DC converter 506 via a 14.3 kΩ resistor 550 and to ground via a 200 kΩ resistor 552. Of course, other resistors can be used interchangeably. Preferably, negative input 536 is connected to amplifier output 534 via a 200 kΩ resistor 554 and also connected to connector jack switch 556 via a 14.3 kΩ resistor 558. In addition to being connected to connector jack 556, resistor 558 is also connected to power output 530 of DC-DC converter 506 via resistor 560. Preferably, resistor 560 has a value of 1.0Ω although other low sense resistor values may be used.

Output voltage 534 of comparator 532 has an output voltage based on the resistor network according to the following formula:

$${V}_{534} = \frac{{R}_{562 , 554}}{{R}_{550 , 558}} ( {V}_{538} - {V}_{536} )$$

Connector jack 556 is a connector through which charge current to device 300 will flow by way of connection to 201 if charging. Accordingly, when no current is flowing through 201 to 300, positive input 538 and negative input 536 of comparator/amplifier 532 will be fixed at the same voltage. Therefore, output voltage 534 will be near 0 volts. However, when connector jack 556 is connected to device 300 through 201 and charge current is flowing, this will result in a different voltage at positive input 538 from that at negative input 536, resulting in a positive, amplified output voltage 534 from comparator/amplifier 532.

Amplifier output 534 is connected to positive input 542 of comparator 532. When connector jack 556 is not connected to device 300 through connection 200, and comparator/amplifier 532 has no voltage difference across input terminals 536 and 538 due to no or insufficient charging current flow through 560, the output voltage 534 and in turn positive input 542 of comparator/amplifier 532 will be below 1.30V. However, when connector jack 556 is connected to device 300 through 200 and charge current is flowing through 560, and there is a voltage difference across input terminals 536 and 538 of comparator/amplifier 532 due to current flow through 560, the output voltage 534 and in turn positive input 542 of comparator/amplifier 532 will be above 1.30V.

The negative input 544 of comparator/amplifier 532 is preferably fixed at 1.3 volts, effectively causing a near zero volts output (“Logic Low”) at 546 due to insufficient difference between 536 and 538 when little to no charge current is flowing to Device 300 through 200. Conversely if sufficient difference between 536 and 538 exists due to charge current flowing at 556 to device 300 through 201, nearly 4.1 volts output (“Logic High”) will be at 546. Comparator output 546 will emit “logic high”, preferably approximately 4.1 volts, when connector jack 556 is connected to device 300 through 200 and charge current is flowing and a logic low, approximately 0 volts, when connector jack 556 is open and no charge current is flowing. Advantageously, integrated circuit 107 will not deliver current charge to a primary battery source of a wireless device when comparator/amplifier 532 determines that there is a difference in voltages between “logic high” and “logic low” positions.

Comparator output 546 is connected to a transistor 562, which is connected to output voltage 530 of DC-DC converter 506 through resistor 564 and a light emitting diode 566. When comparator output 546 is “logic low”, no current runs through resistor 564 and light emitting diode 566. In a preferred embodiment, resistor 566 is lkQ. However, when comparator output 546 is “logic low,” transistor 562 is saturated and current flows through resistor 564 and light emitting diode 566, causing the diode to illuminate.

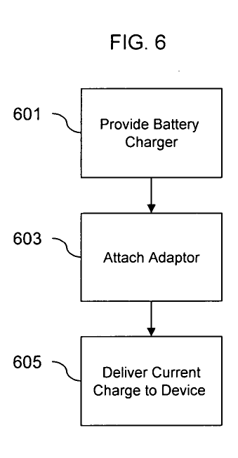

Referring now to FIG. 6, disclosed is a method of charging a wireless device. Initially, a battery charger in accordance with the present invention is provided 601. The battery charger has power source 111 already disposed within housing 101. The battery charger is then attached to an adapter as depicted in step 603. Preferably, the adaptor is adaptor 200 with a terminus as depicted in FIG. 4 (i.e., 202A-D). Of course, power source 111 can be inserted into housing 101 after attaching an acceptable adaptor by removing housing base 105 and inserting in into housing 101. After attaching the adaptor to the battery charger, the adaptor is attached to a wireless device. Attaching adaptor 200 to wireless device 300 results in delivering current charge to the wireless device, thereby charging wireless device 300 as depicted in step 603.

What is claimed is:

1. A battery charger comprising:
a housing;
a power source disposed within said housing;
an integrated circuit disposed within said housing in electrical contact with said power source;
wherein said integrated circuit comprises:
at least one light emitting diode;
a differential op amp;
a DC-DC converter;
a comparator; and
a sensor that monitors current flow;
a means for attaching said charger to a wireless device which is in electrical contact with said integrated circuit such that a charge current is delivered to said wireless device.

2. The battery charger of claim 1 wherein said light emitting diode indicates when said wireless device is being charged.

3. The battery charger of claim 1 wherein said sensor prohibits excess charge current to be delivered to said wireless device.

4. The battery charger of claim 1 wherein said boost converter is a step-up or SEPIC DC-DC converter.

5. The battery charger of claim 1 wherein said sensor is a resistor.

6. The battery charger of claim 4 wherein said sensor resistor is 1.0 ohms.

7. The battery charger of claim 1 wherein said housing is cylindrically shaped.

8. The battery charger of claim 1 wherein said wireless device is comprised of at least one selected from the group consisting of a cellular telephone, a portable digital assistant, a digital media storage device, a digital media playback device, a digital media transmitting device, a digital media receiving device, an iPod®, and a blackberry®.

9. The battery charge of claim 1 wherein said attaching means is an adaptor.

10. The battery charger of claim 1 wherein said power source is an alkaline battery.

11. A method of charging a wireless device comprising the steps of:
providing a battery charger comprising:
a housing;
a power source disposed within said housing;
an integrated circuit disposed within said housing in electrical contact with said power source; wherein said integrated circuit comprises:
at least one light emitting diode;
a differential op amp;
a boost converter;
a push-pull comparator; and
a sensor that monitors current flow;
attaching said battery charger to a wireless device;
wherein a means for attaching said charger to a wireless device is in electrical contact with
said integrated circuit such that a charge
current is delivered to said wireless device; and
charging said wireless device.

12. The method of claim 11 wherein said light emitting diode indicates when said wireless device is being charged.

13. The method of claim 11 wherein said sensor prohibits excess charge current to be delivered to said wireless device.

14. The method of claim 11 wherein said boost converter is a step-up DC-DC converter.

15. The battery charger of claim 11 wherein said sensor is a resistor.

16. The method of claim 15 wherein said sensor resistor is 1.0 ohms.

17. The method of claim 11 wherein said housing is cylindrically shaped.

18. The method of claim 11 wherein said wireless device is comprised of at least one selected from the group consisting of a cellular telephone, a portable digital assistant, a digital media storage device, a digital media playback device, a digital media transmitting device, a digital media receiving device, an iPod®, and a blackberry®.

19. The method of claim 11 wherein said attaching means is an adaptor.

20. The method of claim 11 wherein said power source is an alkaline battery.

21. A wireless device charging system comprising:
a battery charger comprising:
a housing;
a power source disposed within said housing;
an integrated circuit disposed within said housing in electrical contact with said power source comprising:
at least one light emitting diode;
a differential op amp;
a boost or SEPIC DC-DC converter;
a comparator; and
a sensor that monitors current flow;
a means for attaching said charger to a wireless device which is in electrical contact with said integrated circuit such that a charge current is delivered to said wireless device; and
a wireless device comprising at least one rechargeable power source.

22. The system of claim 21 wherein said sensor prohibits excess charge current to be delivered to said wireless device.

23. The system of claim 21 wherein said wireless device is comprised of at least one selected from the group consisting of a cellular telephone, a portable digital assistant, a digital media storage device, a digital media playback device, a digital media transmitting device, a digital media receiving device, an iPod®, and a blackberry®.

24. The system of claim 21 wherein said attaching means is an adaptor.

25. The system of claim 21 wherein said power source is an alkaline battery.

26. The system of claim 21 wherein said rechargeable power source is an alkaline battery.
